(19) United States
(12) Patent Application Publication
(10) Pub. No.: US 2015/0066776 A1
(43) Pub. Date: Mar. 5, 2015

(54) METHOD AND SYSTEM FOR ENHANCING CONTENT SECURITY

(71) Applicants: Andrew Szczeszynski, Beijing (CN); Andrew Wajs, Hoofddorp (NL); Martin Soukup, Ottawa (CA)

(72) Inventors: Andrew Szczeszynski, Beijing (CN); Andrew Wajs, Hoofddorp (NL); Martin Soukup, Ottawa (CA)

(73) Assignee: IRDETO CANADA CORPORATION, Ottawa, ON (CA)

(21) Appl. No.: 14/343,386

(22) PCT Filed: Sep. 7, 2011
(86) PCT No.: PCT/CA2011/001003

§ 371 Date: Nov. 12, 2014

(51) Int. Cl. G06F 21/60; G06Q 50/18; G06Q 10/10

(52) U.S. Cl. CPC G06F 21/602; G06Q 10/10; G06Q 50/184; G06Q 2220/16
USPC 705/57

(57) ABSTRACT

A method and apparatus for enhancing content security including a content corruptor module having an input for encoded content, a content parameter modifier coupled to the input and having outputs for modified content and fixer data, a content encoder coupled to the output for modified content and having an output for encoded modified content and a fixer data encoder coupled to the output for fixer data and having an output for encoded fixer data. The modified encoded content discourages copying as it is not usable with the corrector data.

### CROSS-REFERENCE TO RELATED APPLICATION(S)

This application is the National Stage of International Patent Application No. PCT/CA2011/001003, filed Sep. 7, 2011, the disclosure of which is hereby incorporated by reference in its entirety.

### FIELD OF INVENTION

The present invention relates to methods and systems for enhancing content security and is particularly concerned with audiovisual content.

### BACKGROUND OF THE INVENTION

Audiovisual content is generally available in a compressed format (e.g. MPEG-2, MPEG-4). This content can be stored in a file or streamed to a device containing a content player. This processing sequence is well known and shown in FIG. 1. For example, a content 10 is streamed to a player 12 and shown on a display 14.

Content is often stored locally at devices that are commonly connected to the Internet. Hence, the Internet is an important infrastructure for the distribution of content. Digital Rights Management (DRM) systems aim to control the use of content and attempt to prevent unauthorized distribution of content. A common feature of DRM systems is to store the content in a secured format. FIG. 2 illustrates a typical processing sequence for secured content. A secured content file 20 is streamed to a DRM decrypt component 22 then to the content player 12 for viewing on the display 14.

When a user selects a particular action to be performed on the secured content 20, a DRM decrypt component 22 verifies that the user is entitled to perform the requested operation prior to decrypting the content. If the user has not acquired the necessary rights to the content, the decryption step will fail. This processing scheme makes the redistribution of the secured content file useful to parties that have obtained the necessary rights to the secured content. However, an attacker still may obtain the compressed content at the output of the DRM decrypt component 22 and use that to create a cleartext content file that does not require processing of the DRM system.

Consequently, DRM systems commonly use a secured content player in order to prevent an attacker from obtaining a cleartext version of the compressed content. The associated processing sequence is shown in FIG. 3. A secured content file 20 is streamed to a DRM decrypt component 22 then to a secured content player 30 for viewing on the display 14.

After the decryption process 22, the DRM system transfers the content in a transformed format to the secured player 30, which processes the transformed data into a decompressed format. The secured player 30 makes it difficult for the attacker to obtain the cleartext compressed content. The attacker can still obtain a cleartext uncompressed version of the content, but as redistribution requires recompression with an associated additional quality degradation, this is usually considered as a lower risk. In addition, a DRM system may have further mechanisms to complicate recovering even the uncompressed content. For example, most displays have inputs to accept uncompressed content streams over an encrypted link to increase the complexity of obtaining uncompressed content.

The creation of the secured player 30 usually involves adding some form of obfuscation to the software or using a processor with hardware tamper resistance facilities.

In the Applicant's U.S. Pat. No. 7,050,588, the cleartext compressed content stream contains distortions that are introduced prior to the compression of the content. FIG. 4 illustrates the player side of this arrangement. The secured content 40 is streamed to the decrypt component 22 then demuxed 42 to separate content from fixer data. The content is streamed to the content player 12 while the fixer data is applied to a content fixer 44 that uses the fixer data to correct the content thereby allowing it to be shown on the display 14. This system enables a standard content player 12 to decode the content file as it only produces a distorted result. The content fixer, which is a separate secured module is used to process the decoded stream removing the distortions based on a separate secured stream of fixer data.

The content fixer module 44 makes it possible to use a standard content player 12, which simplifies the integration of the DRM system and a content player. The content fixer module 44 receives a distorted decoded content output and removes the distortions using fixer data that are extracted from the encoded content by the demux module 42.

As the decrypted and demultiplexed compressed content decodes to a distorted content output, the attacker would not be interested in distributing that version of the content. Additionally, it is hard for an attacker to obtain a compressed content stream that produces an undistorted content output from analysing the content fixer 44. As in the secured player described above with regard to FIG. 3, the decoded content is of less interest to an attacker and may also be protected by other means.

The Applicant's U.S. Pat. No. 7,050,588 requires the content to be distorted prior to compression as shown in FIG. 5. The content 10 is streamed to a content corruptor 50 then to a content encoder 52, a fixer data encoder 54 receives both the original content and the corrupted content so it can derive a fixer data stream, which it encodes for muxing 56 with the encoded content stream. The combined streams are then encrypted 58 to produce the secured content 40

The fixer data encoder 54 uses the difference between the corrupted content and the original content, which is used to encode a correcting signal, the fixer data stream.

Because the content corruption 50 takes place prior to the content encoding (compression) 52, it forces the content encoder 52 to process content material for which it may not be well suited. Distorting the content prior to encoding thus may impact the degree of distortion that can be achieved as the content encoding module 52 may not be able to handle higher levels of distortion. Positioning the distortion process 50 prior to the compression module 52 also significantly increases the bandwidth of the encoded content and/or results in a lower quality encoding. In order to revert the distortion after the decoding, a correction signal needs to be provided. As the content encoder operates independently of the distortion process, the fixer data encoder module 54 produces a correction signal that restores the distorted content to the original content. As the content encoder 52 typically uses lossy compression techniques, applying the correction signal to the decoded content output can result in content output with noticeable quality degradations.

Methods and systems are disclosed herein for enhancing content security to obviate or mitigate at least some of the aforementioned disadvantages.

### BRIEF DESCRIPTION OF THE DRAWINGS

The present disclosure will be further understood from the following detailed description with reference to the drawings in which:

FIG. 1 illustrates a known content player system;

FIG. 2 illustrates a known secured content system;

FIG. 3 illustrates a known secured player system;

FIG. 4 illustrates a known system with enhanced security for an unsecured content player;

FIG. 5 illustrates an encoding system for the system of FIG. 4;

FIG. 6 illustrates a component for enhancing content security in accordance with the present disclosure;

FIG. 7 illustrates the content security component of FIG. 6 in further detail;

FIG. 8 illustrates another embodiment of a system for enhancing content security using the component of FIG. 6;

FIG. 9 illustrates a system for processing a combined content stream as produced by the system of FIG. 8;

FIG. 10 illustrates another embodiment of a system for processing a combined content stream as produced by the system of FIG. 8;

FIG. 11 illustrates applying the present content corruptor to secure a content player;

FIG. 12 illustrates alternative embodiment of FIG. 11;

FIG. 13 illustrate a typical MPEG2 video encoding process;

FIG. 14 illustrates a typical MPEG2 video decoding process;

FIG. 15 illustrates applying the present content corruption module to the process of FIG. 14;

FIG. 16 illustrates performing of frequency fixup right after inverse DCT;

FIG. 17 illustrates applying the corruptor module to the preparation of secured content;

FIG. 18 illustrates decoding the content secured by the system of FIG. 17; and

FIG. 19 illustrates alternative embodiment of FIG. 12.

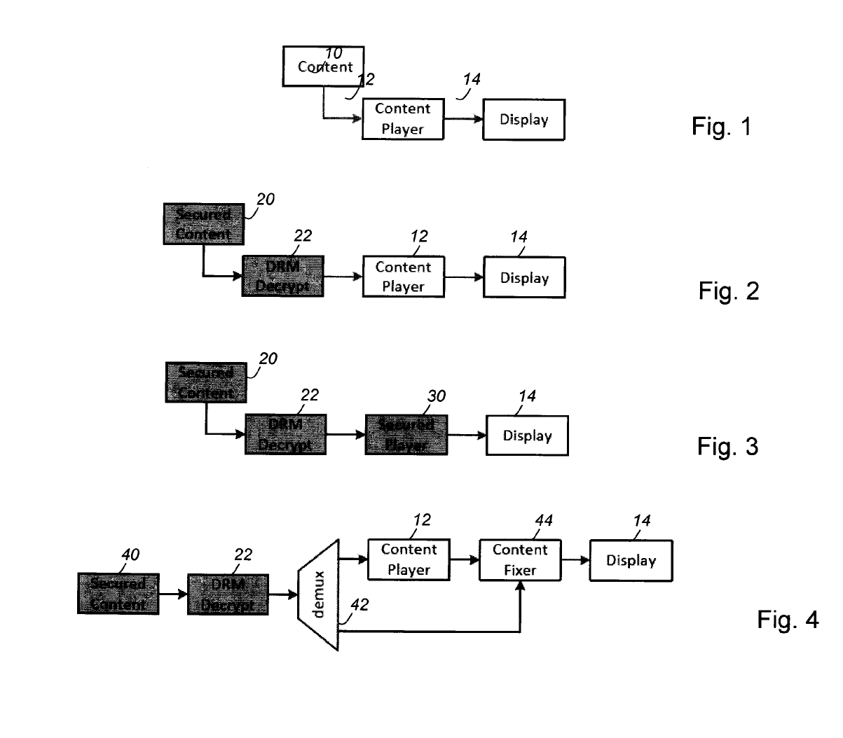

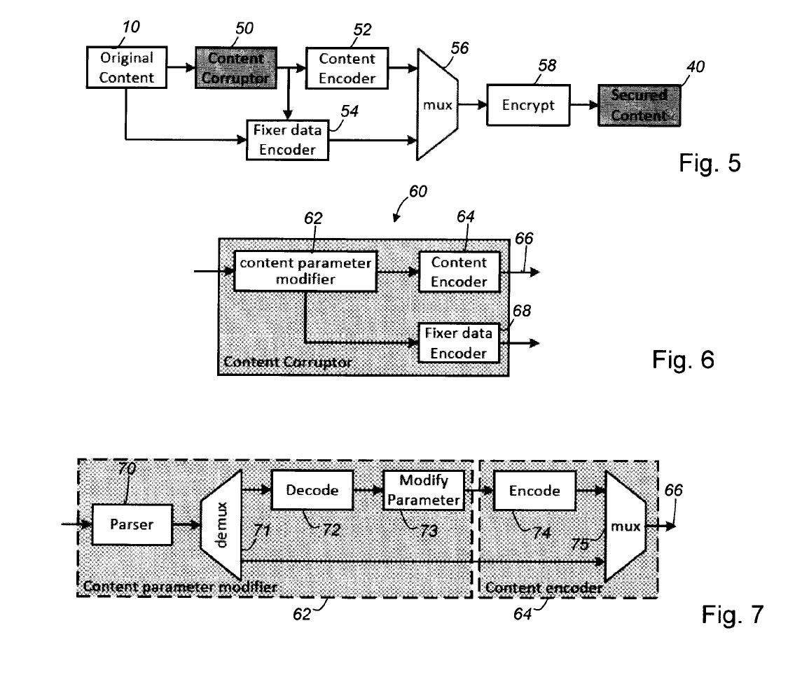

### DETAILED DESCRIPTION

The disclosed embodiment applies the distortion on encoded data. Using the encoded data allows a content corruptor module to be combined in the encoding chain or in the decoding chain.

Conveniently, in order to remove the distortion the content player is split into two components between which a content fixer module is inserted to adapt the partially decoded content. These adaptations enable the second component to generate an undistorted content output.

The embodiment supports an efficient integration with existing content players and maintains the difficulty for an attacker to obtain an encoded content stream that decodes to an undistorted content output. As the embodiment modifies the encoding of the content, it can achieve high levels of distortion and still support distortion free content output from the content player. Modifications to the parameters in the encoded content also result in a more efficient coding of the content fixer data.

An advantage of the embodiment is that distortion can occur on the receiving device, thus the restrictions imposed by the transmition process are no longer relevant, thus allowing much higher levels of distortion to be added.

An advantage of the embodiment is that interdependence of corruption data can be added, for example each previous frame seeds the next RNG, which can prevent stream splicing. This would, for example, prevent republishing content with the advertisements removed.

FIG. 6 illustrates a content corruptor component for enhancing content security in accordance with the present disclosure. The content corruptor component 60 introduces distortions in the encoded domain.

The content corruptor component 60 includes a content parameter modifier module 62 that parses the data structures of the content, decodes some of these datastructures and modifies one or more parameters contained in the decoded data. A content encoder module 64 converts the modified datastructures into an efficiently coded datastructure and merges them with the remaining unmodified parts of the content to produce an encoded content stream or file as an output 66 of the content corrupter component 60. The produced content can be decodable by a standard decoder, but this would result in a distorted content output. The fixer data encoder module 68 in the content corruptor component 60 receives the modifications that have been made to the parameters in the decoded data and encodes them in a format that allows a content fixer module in the receiver to compensate for the modified parameters in the content.

FIG. 7 illustrates the content corruptor component of FIG. 6 in further detail. The parameter modifier module 62 includes a data parser 70 parses the data structures of the content, a demux 71 that passes some of the data structures to a partial decoder 72 that decodes these datastructures so that a parameter modifier component 73 can modify one or more parameters contained in the decoded data. The content encoder module 64 includes an encoder 74 that converts the modified datastructures into an efficiently coded datastructure and a mux 75 that merges them with the remaining unmodified parts of the content to produce an encoded content stream or file as the output 66 of the content corrupter component 60. The path for the encoded fixer data that enables a receiver to compensate for the modified parameters in the content is not shown in FIG. 7. Delivery of the fixer data is dependent upon whether the corruption is done on the same device or a different device.

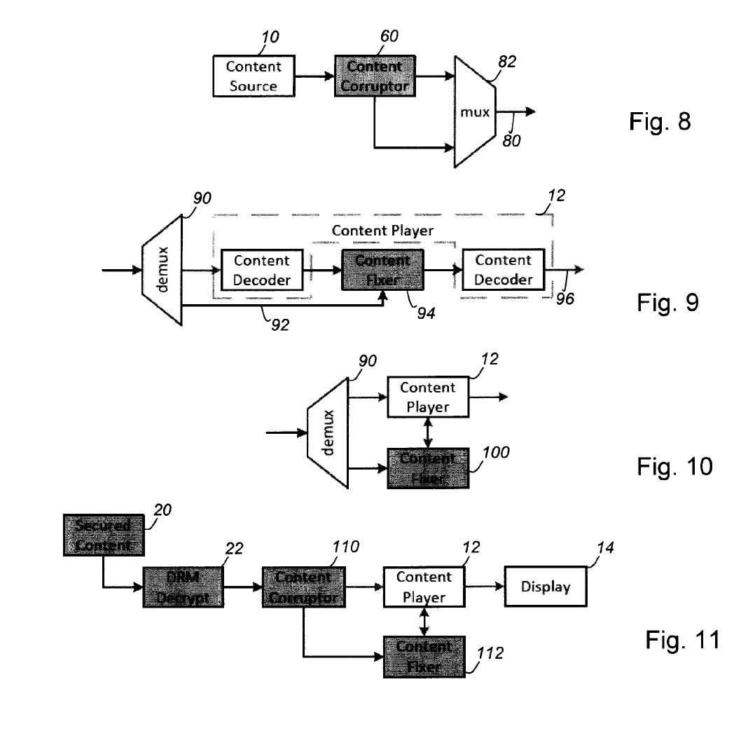

FIG. 8 illustrates another embodiment of a system for enhancing content security using the component of FIG. 6. It may be useful for some applications to combine the encoded content and encoded fixer data signals into a single output 80 using, for example a mux 82. The content source such as a content encoder, a content receiver or a content decryptor outputs the decoded data for processing by the content corruptor. The two outputs of the content corruptor module 60 are combined in the mux 82 to produce a single content stream or a content file 80. This step may not be necessary in some applications of the present disclosure.

FIG. 9 illustrates a system for processing a combined content stream as produced by the system of FIG. 8. After a demux 90 extracts the content fixer data 92 from the input a normal encoded content stream is produced. The content player 10 can decode the content. At a relevant point in the decoding process, the content fixer 94 receives the partially decoded content and compensates for the effects caused by the modified parameters in the encoded content. The content fixer 94 uses the encoded content fixer data 92 to drive the compensation. The compensated content is further decoded by the second part of the content player 10 to produce the content output 96 without any distortions. As the content fixer module 94 is implemented in a secured manner, it is difficult for an attacker to obtain an encoded content stream that decodes to an undistorted version of the content. Attacks on the uncompressed content are possible as described in earlier sections of this document. This is a common feature of secured content players.

FIG. 10 illustrates another embodiment of a system for processing a combined content stream as produced by the system of FIG. 8. Instead of passing the partially decoded content to the content fixer module, the same functionality can be achieved using an API that allows an external module 100 to make modifications to partially decoded content.

FIG. 11 illustrates applying the content corruptor of FIG. 6 to secure a content player. The system of FIG. 11 combines a secured implementation of a content corruption module 110 with a content fixer module 112 that allows a straight forward integration with third party content players.

The secured content 20 is generally stored in encrypted form. Hence the first step is to convert it into a cleartext format using the DRM decrypt component 22. In a software application, this can be implemented by a whitebox decryption module which outputs the content using an output transform to the content corruption module 110. The corruption could also be applied by the whitebox decryption module (i.e. it is the transform applied).

The content corruption module 110 processes the content and modifies the content encoding parameters introducing substantial distortions of the content. The modified content stream is output as a cleartext encoded content stream to an unsecured content player 10. The content corruptor 110 also generates the data needed to correct the changes made to these content encoding parameters. This results in a transformed correction signal output that is transmitted to the content fixer module 112.

The content player 10 that decodes the signal is not secured. Some decoding steps are augmented by a call to the content fixer module 112 to request changes for some of the decoded values used in the content player processing. The decoding requests can be placed after full decoding, or closer to a key decompression step, such as after Inverse Discrete Cosine Transform (IDCT) used in Video decompression. As these steps operate on (partly or fully) decoded content, it is difficult for an attacker to combine the two inputs of the content player 10 to generate the uncorrupted encoded content stream.

As the content is corrupted prior to the content player, it is possible to establish a unique distortion for every time that the secured content is being played. The content corruption module 110 may use a source of randomness to achieve a different distortion for different processing requests.

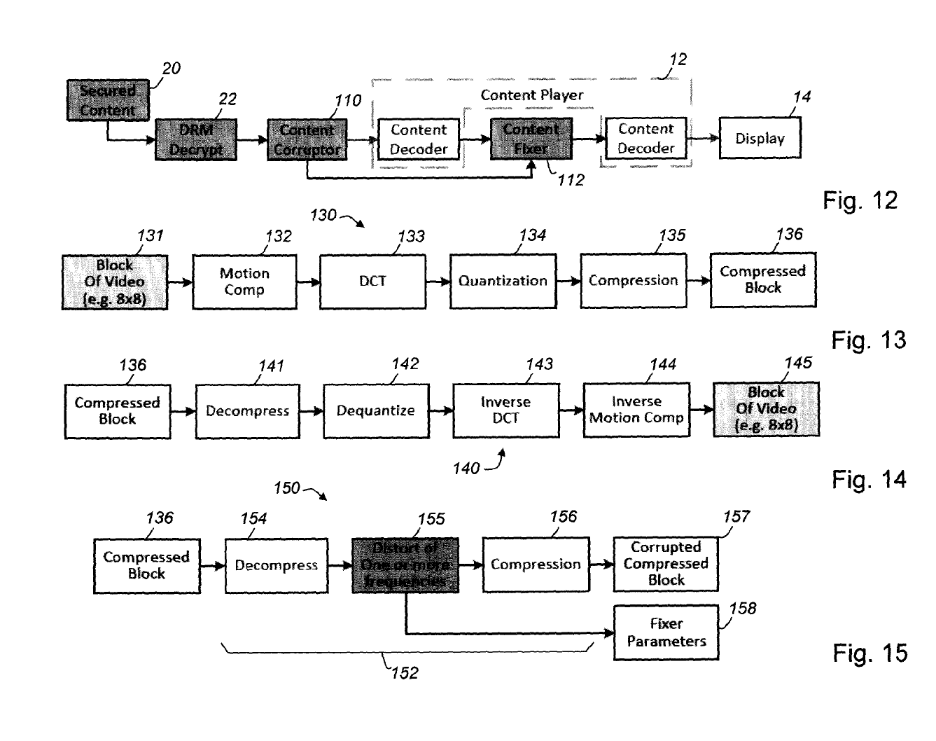

FIG. 12 illustrates an alternative embodiment of FIG. 11 that relies on redirecting the partially decoded content to the content fixer module as shown in the diagram below. The main difference with the previous example is in the interface between the content player and the content fixer.

Many common video compression standards achieve compression by using the 2-dimensional Discrete Cosine Transform (DCT). Pixel-based video data is transformed using DCT into a frequency representation, which allows the codec to reduce the amount of information sent in frequencies that are not as important to our eyes. For instance, an 8 by 8 pixel block in MPEG2 would be converted using:

$$F ( u , v ) = \frac{2}{N} C ( u ) C ( v ) {\sum }_{x = 0}^{N - 1} {\sum }_{y = 0}^{N - 1} f ( x , y ) cos \frac{( 2 x + 1 ) u π}{2 N} cos \frac{( 2 y + 1 ) v π}{2 N}$$

$$C ( u ) , C ( v ) = \{ \begin{matrix}\frac{1}{\sqrt{2}} & for u , v = 0 \\ 1 & otherwise .\end{matrix}$$

FIG. 13 illustrates a typical MPEG2 video encoding process. The MPEG2 process 130 includes taking a block of video 131 compensating for motion 132, performing a discrete cosine transform 133, quantizing 134, and compressing 135 to produce a compressed block 136. The Motion Comp(ensation) module 132 allows compression to be increased by re-using parts of previous frames. The Discrete Cosine Transform module (DCT) 133 converts the pixel-based information into frequency-based. The Quantization module 134 lowers the size of the encoded content by reducing less important frequencies more than important frequencies. Compression 135 further reduces the bandwidth by efficiently representing common patterns.

FIG. 14 illustrates a typical MPEG2 video decoding process. On the content decoding side, the inverse of this process 140 is implemented. That is decompressing 141, dequantizing 1423, inverse DCT 143, and inverse motion comp 144 to produce a block of video 145.

FIG. 15 illustrates applying the present content corruption module after the process of FIG. 13. When the compressed video 136 arrives at a device 150, a content corruption module 152 would decompress the block 154, alter one or more frequencies 155, and then recompress the block 156 to produce a corrupted compressed block 157, while the frequency distortion block 155 outputs fixer parameters 158,

To improve security, the compressed block can have a transformation applied to it, and the corruption can be altered to work in the transformed space.

The DCT transform is a linear transform. This implies that the fixup required to reverse the corruption of one frequency is independent of the value of other frequencies. In addition, the fixup is proportional to the amount by which the frequency was changed. This allows for a very efficient fixup by using pre-calculated tables. For each frequency, a fixup table is calculated for a particular change. When a block is fixed up, for each frequency that was altered, a scaled version of the corresponding fixup table is added to the pixel block.

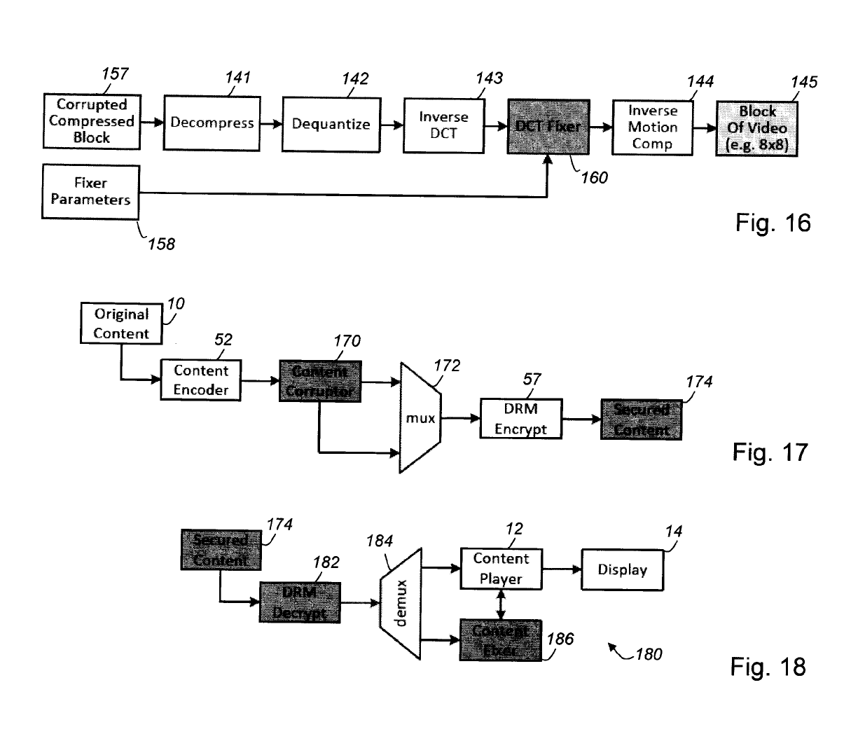

For video codecs, an accessible place to perform fixup is right after Inverse DCT as shown in FIG. 16. The decoding sequence is the same as FIG. 14 except for the addition of a DCT fixer module 160.

The process is optimal if the fixup happens before saturation. This allows the corruption to perform arbitrary changes without worrying if the resulting DCT representation remains within the normal range of pixel values. Otherwise, the corruption needs to be careful so that the resulted corrupted blocks do not overflow or underflow pixel values before they are fixed up.

If fixup happens after motion compensation, then the corruption needs to make sure not to affect blocks that take part in motion compensation. Alternatively, fixup needs to take into account the effects of motion compensation and undo them.

Fixup may be added after all decoding, but care must be taken so that post-processing effects, such as deblocking or smoothing, are taken into account.

DCT is just one type of corruption that can be performed. Other types of corruptions could be performed. For instance, motion vectors may be modified by the corruptor in a way that can be reversed in the pixel domain after motion compensation, such as reversing the frame and vectors, or offsetting them, or scaling. Quantization matrices could be altered so that the pixel data needs to be scaled. Reversible wavelet coefficients may be modified in a manner similar to DCT, taking into account overlap. Block order could also be altered so that blocks and their intra-block prediction need to be swapped.

It is possible to apply the corruptor module to the preparation of secured content as shown in FIG. 17. The original content 10 is streamed to the content encoder 52 then a content corruptor 170, which outputs corrupted content and fixer data to a mux 172, which combines the signals and sends its output to the DRM encrypt component 57 to produce secured content 174. The sequence establishes a secured content file 174 that consists of the encoded but corrupted content and combined with a metadata stream that is needed to correct the distortions in the output of the content player.

The advantage of this variant is that the secured content corruptor module 170 is not needed in the processing of the secured content 174 as shown in FIG. 18. The decoding system 180 includes a DRM decrypt component 182 a demux 184 a content fixer module 186 and the content player 12 and the display 14.

The decryption module 182 decrypts both the content stream and the parameter stream to correct the encoding parameters upon request of the content player 12. As the content corruption is done at the creation of the secured content, the content corruption is fixed.

Another possible variant is to combine a corrupted content with a further corruption step in the content rendering process.

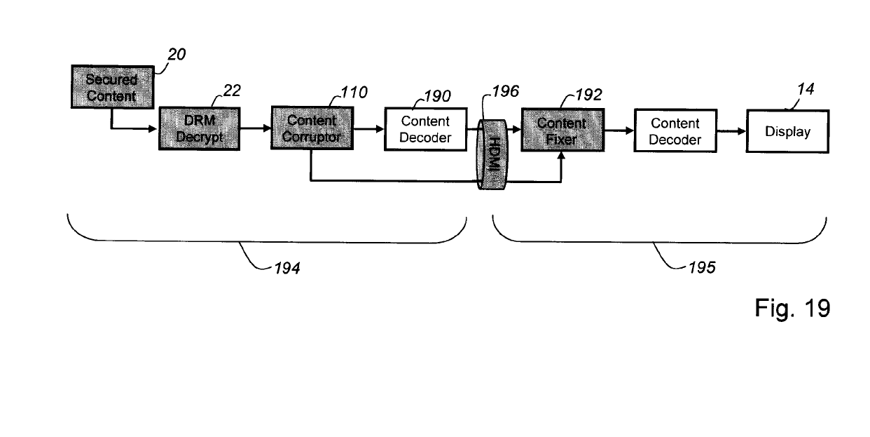

FIG. 19 illustrates alternative embodiment of FIG. 12. The embodiment of FIG. 19 shows a first content decoder 190 and the content fixer 192 are distributed over two devices 194 and 195, the first device 194 runs in the content receiver/player and the second device 195 is the display device. The devices 194 and 195 are shown interconnected with a secured HDMI interface 196, although other interfaces are possible.

Numerous modifications, variations and adaptations may be made to the particular embodiments described above without departing from the scope patent disclosure, which is defined in the claims.

What is claimed is:

1. A system for enhancing content security comprising:
a content corruptor module having
an input for encoded content;
a content parameter modifier coupled to the input and having outputs for modified content and fixer data
a content encoder coupled to the output for modified content and having an output for encoded modified content; and
a fixer data encoder coupled to the output for fixer data and having an output for encoded fixer data.

2. The system of claim 1, wherein the content parameter modifier includes a data parser coupled to the input for parsing into data structures, a demultiplexor for selecting a subset of data structures for modification, a decoder for decoding the subset of data structures, and a parameter modifier for modifying parameters of the selected subset of data structures.

3. The system of claim 1 or 2, wherein the content encoder includes an encoder for encoding the modified content and a multiplexor combining the modified content with unmodified content for providing the encoded modified content.

4. The system of any one of claims 1, 2 and 3 wherein the outputs for encoded modified content and encoded fixer data are coupled to a multiplexor for providing a combined encoded output.

5. The system of any one of claims 1 to 4, wherein the content modifier changes at least one discrete cosine transform (DCT) parameter.

6. The system of any one of claims 1 to 4, wherein the content modifier changes at least one motion vector parameter.

7. The system of 6, wherein the content modifier changes at least one of frame and vector order, vector offset and vector scale.

8. The system of any one of claims 1 to 4, wherein the content modifier alters quantization matrices.

9. The system of any one of claims 1 to 4, wherein the content modifier reverses wavelet coeeficients,

10. The system of any one of claims 1 to 4, wherein the content modifier alters block order.

11. A content player comprising the content corruptor of any one of claims 1 to 10.

12. The content player of claim 11 including a content fixer having an input coupled to the encoded fixer data output for receiving fixer data and correcting the modified content.

13. A secured content creator comprising the content corruptor of any one of claims 1-10 and a content encryptor coupled to the outputs thereof.

14. A content player for playing the output of the secured content creator of claim 13 including a content fixer having an input for receiving fixer data for correcting the modified content.

15. A method of enhancing content security comprising the steps of:
inputting an encoded content stream;
modifying parameters to produce a modified encoded content stream;
generating an encoded fixer data stream in dependence upon an amount of modification of the parameters; and
outputting the modified encoded content stream and the encoded fixer data stream.

16. The method of claim 15, wherein the content modifying step changes at least one discrete cosine transform (DCT) parameter.

17. The method of claim 15, wherein the content modifying step changes at least one motion vector parameter.

18. The method of claim 15, wherein the content modifying step changes at least one of frame and vector order, vector offset and vector scale.

19. The method of claim 15, wherein the content modifying step alters quantization matrices.

20. The method of claim 15, wherein the step of modifying reverses wavelet coeeficients,

21. The method of claim 15, wherein the step of modifying alters block order.
